(19) United States
(12) Patent Application Publication
(10) Pub. No.: US 2026/0194679 A1
(43) Pub. Date: Jul. 9, 2026

(54) METHOD AND DEVICE FOR DETERMINING FULL-AREA APPARAENT RESISTIVITY OF STRATUM

(71) Applicant: INSTITUTE OF GEOLOGY AND GEOPHYSICS, CHINESE ACADEMY OF SCIENCES, BEIJING CITY (CN)

(72) Inventors: PENGFEI LIANG, BEIJING CITY (CN); QINGYUN DI, BEIJING CITY (CN); WENXIU ZHANG, BEIJING CITY (CN); WENXUAN CHEN, BEIJING CITY (CN)

(21) Appl. No.: 19/010,194

(22) Filed: Jan. 6, 2025

(51) Int. Cl. G01V 3/10

(52) U.S. Cl. CPC G01V 3/10

(57) ABSTRACT

A method and a device for determining a full-area apparent resistivity of a stratum are related to the exploration instrumentation and include: acquiring suspension data of the exploration instrument in air and observation data within the target stratum; determining an observation ratio based on the suspension data and the observation data; and determining the full-area apparent resistivity of the target stratum based on the observation ratio.

### FIELD OF THE DISCLOSURE

The present disclosure relates to the technical field of exploration instruments, and particularly to a method and a device for determining a full-area apparent resistivity of a stratum.

### BACKGROUND OF THE DISCLOSURE

The Transient Magnetic Method (TMM) is an advanced geophysical exploration technology that enables geologists to acquire stratum resistivity information of a stratum during drilling without interrupting the drilling operation. This technique utilizes the principle of electromagnetic induction by transmitting a brief magnetic field pulse into the subsurface and then measuring the resulting changes in the magnetic field caused by the conductivity of a stratum to infer resistivity.

In the TMM-based stratum exploration process, the resistivity of the drill collar is a critical factor, as it can influence the magnetic field signal received. The drill collar, typically made of metal with a specific resistivity, is a component of the drilling tool. When a magnetic field pulse is transmitted, the resistivity of the drill collar affects the propagation and reception of the magnetic waves. Specifically, a high resistivity of the drill collar enables it to absorb more magnetic energy, which may alter the propagation path of magnetic field waves, thereby impacting the accuracy of resistivity measurements of a stratum.

### SUMMARY OF THE DISCLOSURE

The present disclosure provides a method and a device for determining a full-area apparent resistivity of a stratum, so as to resolve at least one of the aforementioned technical challenges.

The present disclosure provides a method for determining a full-area apparent resistivity of a stratum, which includes: acquiring suspension data of an exploration instrument in air and observation data within a target stratum; determining an observation ratio based on the suspension data and the observation data; and determining the full-area apparent resistivity of the target stratum based on the observation ratio.

According to the method for determining a full-area apparent resistivity of a stratum provided by the present disclosure, the present disclosure further provides a device for determining a full-area apparent resistivity of a stratum, which includes: an acquisition module configured to acquire suspension data of an exploration instrument in air and observation data within a target stratum; a first determination module configured to determine an observation ratio based on the suspension data and the observation data; and a second determination module configured to determine the full-area apparent resistivity of the target stratum based on the observation ratio.

Further, the present disclosure provides an electronic device, which includes a memory, a processor, and a computer program stored in the memory and executable on the processor. The process is configured to implement any of the methods for determining the full-area apparent resistivity of the stratum as described.

Moreover, the present disclosure provides a non-transitory computer-readable storage medium on which a computer program is stored. When executed by a processor, the computer program implements any of the methods for determining full-area apparent resistivity of a stratum as described.

The method and the device for determining the full-area apparent resistivity of the stratum provided by the present disclosure include: acquiring the suspension data of the exploration instrument in the air and the observation data within the target stratum; determining the observation ratio based on the suspension data and the observation data; and determining the full-area apparent resistivity of the target stratum based on the observation ratio. By acquiring the suspension data measured by the exploration instrument in the air and the observation data measured within the target stratum in the present disclosure, the observation ratio between the suspension data and the observation data can be acquired through the calculation, and the observation ratio is used to process the observation signal, so that the influence of drilling noise on the observation data can be suppressed and the accuracy in calculating the full-area apparent resistivity of the target stratum can be improved.

### BRIEF DESCRIPTION OF THE DRAWINGS

To better explain the technical solutions of the present disclosure or the prior art, a brief description of the drawings used in the examples or prior art is provided below. It is evident that the following drawings represent some examples of the present disclosure, and those skilled in the art could derive other drawings based on these drawings without creative labor.

FIG. 1 is a flowchart illustrating the method for determining a full-area apparent resistivity of a stratum provided by the present disclosure.

FIG. 2 is a diagram showing a change in an observation ratio of a coaxial response when a resistivity gradually decreases according to one embodiment of the present disclosure.

FIG. 3 is a diagram showing the change in the observation ratio of the coaxial response when the resistivity gradually increases according to one embodiment of the present disclosure.

FIG. 4 is a diagram showing the change in an observation ratio of a coplanar response when the resistivity gradually decreases according to one embodiment of the present disclosure.

FIG. 5 is a diagram showing the change in the observation ratio of the coplanar response when the resistivity gradually increases according to one embodiment of the present disclosure.

FIG. 6 is a schematic diagram illustrating a structure of a device for determining a full-area apparent resistivity of a stratum provided by the present disclosure.

FIG. 7 is a schematic diagram illustrating a structure of an electronic device provided by the present disclosure.

### DETAILED DESCRIPTION OF THE EXEMPLARY EMBODIMENTS

To make the objectives, technical solutions, and advantages of the present disclosure clearer, the following sections provide a detailed and complete description of the technical solutions in conjunction with the drawings. It is apparent that the described embodiments represent some but not all embodiments of the present disclosure. All other embodiments obtained by those skilled in the art without creative efforts, based on the embodiments of the present disclosure, are within the scope of protection of the present disclosure.

It should be understood that, although terms like “first,” “second,” etc., may be used in one or more embodiments of the present disclosure to describe various information, these terms should not be limited by these labels. These terms are only used to distinguish similar information from each other. For instance, within the scope of one or more embodiments, “first” may alternatively be called “second,” and similarly, “second” may also be called “first.” Depending on the context, terms such as “if” as used here can be interpreted as “when” or “in response to.”

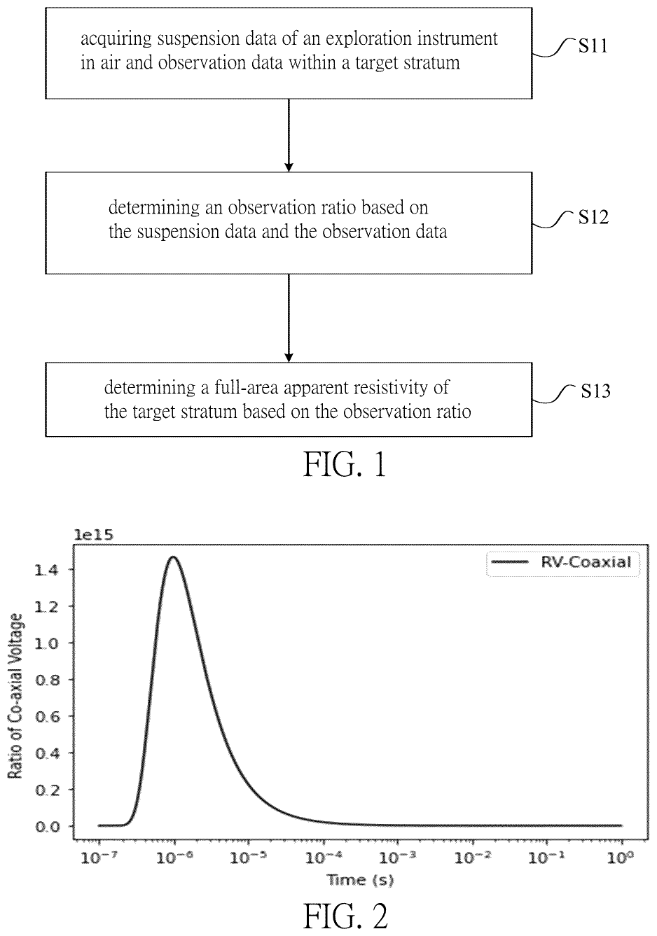

FIG. 1 is a flow diagram illustrating a method for determining a full-area apparent resistivity of a stratum provided by the present disclosure. As shown in FIG. 1, the method includes the following steps.

S11: acquiring suspension data of an exploration instrument in air and observation data within a target stratum.

It should be noted that the suspension data refers to data acquired when the exploration instrument is suspended in the air, i.e., data measured solely from transmission of signals and reception of electromagnetic waves between the ground-based transmission and reception antennas, which reflects the propagation characteristics of electromagnetic waves in the air without any response from the underground medium. This data can be used to correct interferences in the observation data from the stratum, such as those caused by the drill collar.

It should be noted that the observation data refers to data detected by the reception antenna as electromagnetic waves propagate through the underground medium in the target stratum. This data contains electrical information about the subsurface medium, but may also be affected by electromagnetic interference from metal objects like the drill collar. The same excitation source is used in both the air and the unknown target stratum.

S12: determining an observation ratio based on the suspension data and the observation data.

Specifically, to ensure data quality and reliability, the suspension data and the observation data can undergo preprocessing, such as denoising, filtering, and normalization. Then, the ratio between the suspension data and the observation data is calculated and used as the observation ratio. The observation ratio can be used to correct interference factors in the observation data, such as the impact of the drill collar on the signal.

In one embodiment, for a coaxial transient magnetic field scenario, the suspension data and the observation data are data based on a vertical magnetic field component measured by a Z-axis transmission antenna and a Z-axis reception antenna of the exploration instrument. An observation ratio corresponding to the Z-axis vertical magnetic field component is then calculated based on the suspension data and the observation data corresponding to the Z-axis vertical magnetic field component. The coaxial transient magnetic field detection involves one transmitting coil and one or more receiving coils, all aligned along the same axis.

In another embodiment, for a coplanar transient magnetic field scenario, the suspension data and the observation data are data based on a horizontal magnetic field component measured by a horizontal transmission antenna and a horizontal reception antenna of the exploration instrument. An observation ratio corresponding to the horizontal magnetic field component is then calculated based on the suspension data and the observation data corresponding to the horizontal magnetic field component. The coplanar transient magnetic field detection typically involves one or more coil planes, which may be parallel or overlapping.

S13: determining the full-area apparent resistivity of the target stratum based on the observation ratio.

Specifically, a distance between the transmission antenna and the reception antenna of the exploration instrument, an air resistivity, a magnetic permeability of a vacuum, and an observation time range are determined, and different observation times within the observation time range correspond to different exploration depths. For example, the distance between the transmission antenna and the reception antenna can be set to 1 meter, with the air resistivity typically set to 10⁻¹⁰ S/m. The magnetic permeability of the vacuum is constant for calculating electromagnetic wave propagation. The observation time range can be set from [10⁻⁷, 1] seconds. The resistivity distribution of a stratum medium is then iteratively calculated by combining the air resistivity, the magnetic permeability of the vacuum, the observation time range, the observation ratio, and the distance, to acquire the full-area apparent resistivity of the target stratum, i.e., the resistivity distribution of the target stratum.

The embodiment of the present disclosure thus provides a solution involving: acquiring the suspension data of the exploration instrument in the air and the observation data within the target stratum; determining the observation ratio based on the suspension data and the observation data; and determining the full-area apparent resistivity of the target stratum based on the observation ratio. By acquiring the suspension data measured by the exploration instrument in the air and the observation data measured within the target stratum in the embodiment of the present disclosure, the observation ratio between the suspension data and the observation data can be acquired through the calculation, and the observation ratio is used to process the observation signal, so that the influence of drilling noise on the observation data can be suppressed and the accuracy in calculating the full-area apparent resistivity of the target stratum can be improved.

In one embodiment of the present disclosure, determining the full-area apparent resistivity of the target stratum based on the observation ratio and the distance includes the following steps.

Determining the distance between the transmission antenna and the reception antenna of the exploration instrument, the air resistivity, the magnetic permeability of the vacuum, and the observation time range, wherein different observation times within the observation time range correspond to different exploration depths. The full-area apparent resistivity of the target stratum can be acquired by using an iterative calculation based on the air resistivity, the magnetic permeability of the vacuum, the observation time range, the observation ratio, and the distance,

It should be noted that the full-area apparent resistivity can include a full-area apparent resistivity corresponding to the horizontal magnetic field component and a full-area apparent resistivity corresponding to the Z-axis vertical magnetic field component. Specifically, the distance between the transmission antenna and the reception antenna of the exploration instrument, the air resistivity, the magnetic permeability of the vacuum, and the observation time range are determined. Afterwards, the full-area apparent resistivity in the target stratum is acquired by using the iterative calculation or search methods based on the air resistivity, the magnetic permeability of the vacuum, the observation time range, the observation ratio, and the distance, so that the resistivity distribution of target stratum can be acquired. The iterative calculation or search methods are existing mature algorithms in the field, and thus the specific calculation process is not described here.

For the coaxial transient magnetic field, the calculation formula for the full-area apparent resistivity corresponding to the Z-axis vertical magnetic field component is as follows.

$${RV}_{coa}^{21} ( t ) = {( \frac{{σ}_{2}}{{σ}_{1}} )}^{\frac{3}{2}} {e}^{\frac{{μ}_{0} {L}^{2}}{4 t} ( - {σ}_{2} + {σ}_{1} )} = {( \frac{{σ}_{2}}{t} / \frac{{σ}_{1}}{t} )}^{\frac{3}{2}} {e}^{\frac{{μ}_{0} {L}^{2}}{4} ( \frac{- {σ}_{2}}{t} )} {e}^{\frac{{μ}_{0} {L}^{2}}{4} ( \frac{{σ}_{1}}{t} )}$$

$${RV}_{coa}^{21} ( t )$$

is the observation ratio, σ₁ is the air resistivity, σ₂ is the full-area apparent resistivity of the target stratum to be determined, μ₀ is the magnetic permeability of the vacuum, L is the distance, and t is the observation time. In one specific example, the observation time range is set from [10⁻⁷, 1] seconds, the distance is 1 meter, and the air resistivity is 10⁻¹⁰ S/m to simulate the air suspension calibration scenario of the exploration instrument. The resistivity of the target stratum varies over time, and the simulation of the resistivity of the target stratum varies with the depth (as different observation times correspond to different probing depths). When the resistivity of the target stratum gradually decreases over time from [10, 10⁻⁴] S/m, the observation ratio changes with time, as shown in FIG. 2. FIG. 2 is a diagram showing the change in the observation ratio of a coaxial response when the resistivity gradually decreases according to one embodiment of the present disclosure. When the resistivity of the target stratum decreases over time as shown in FIG. 2, the observation ratio of the coaxial response varies with the function of t/σ₂.

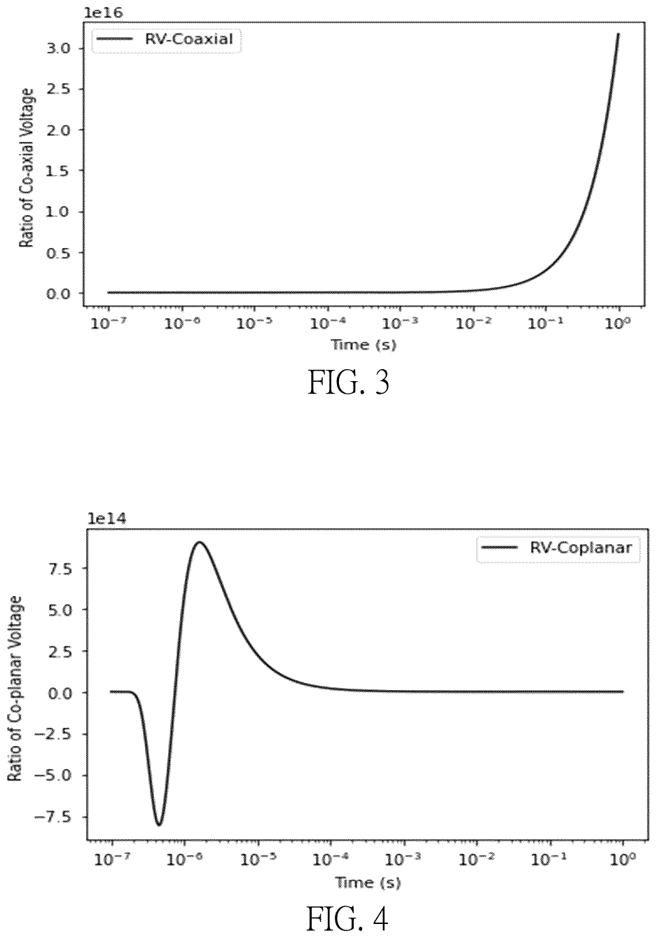

When the resistivity of the target stratum gradually increases over time from [10⁻⁴, 10] S/m, the observation ratio varies with time, as shown in FIG. 3. FIG. 3 is a diagram showing the change in the observation ratio of coaxial response when the resistivity gradually increases according to one embodiment of the present disclosure. When the resistivity of the target stratum increases over time as shown in FIG. 3, the observation ratio of the coaxial response varies with the function of t/σ₂.

By examining the data changes in FIG. 2 and FIG. 3, it is observed that when the time is greater than 10⁻⁶ s, the observation ratio of the coaxial response changes monotonically with time. This monotonic change allows the full-area apparent resistivity of the target stratum to be calculated through iterative calculation or search methods, thereby determining full-area apparent resistivity in the target stratum.

For the coplanar transient magnetic field, the calculation formula for the full-area apparent resistivity corresponding to the horizontal magnetic field component is as follows.

$$\begin{matrix}{RV}_{cop}^{21} ( t ) = {( \frac{{σ}_{4}}{{σ}_{3}} )}^{\frac{3}{2}} \frac{4 t - {μ}_{0} {σ}_{4} {L}^{2}}{4 t - {μ}_{0} {σ}_{3} {L}^{2}} {e}^{\frac{{μ}_{0} {L}^{2}}{4 t} ( - {σ}_{4} + {σ}_{3} )} \\ = {( \frac{{σ}_{4} / t}{{σ}_{3} / t} )}^{\frac{3}{2}} \frac{4 - {μ}_{0} {L}^{2} {σ}_{4} / t}{4 - {μ}_{0} {L}^{2} {σ}_{3} / t} {e}^{\frac{{μ}_{0} {L}^{2}}{4 t} ( \frac{- {σ}_{4}}{t} )} {e}^{\frac{{μ}_{0} {L}^{2}}{4 t} ( \frac{{σ}_{3}}{t} )}\end{matrix}$$

$${RV}_{cop}^{21} ( t )$$

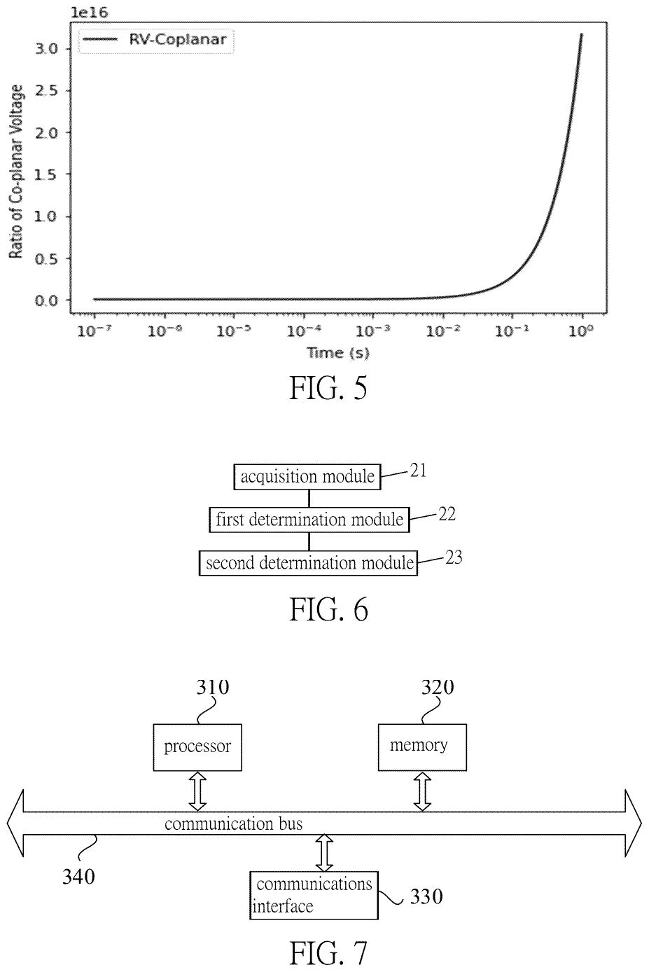

is the observation ratio, σ₃ represents the air resistivity, σ₄ is the full-area apparent resistivity of the target stratum to be determined, μ₀ denotes the magnetic permeability of the vacuum, L is the distance, and t is the observation time. In one specific example, the observation time range is set to [10⁻⁷, 1] seconds, the distance is 1 meter and the air resistivity σ₃=10⁻¹⁰ S/m, to simulate the calibration condition of the suspended exploration instrument. The resistivity of the target stratum varies over time, and simulation of the resistivity changes in a layered stratum model (as different observation times correspond to different probing depths). When the resistivity of the target stratum gradually decreases over time from [10, 10⁻⁴] S/m, the variation of the observation ratio of coplanar response with time is shown in FIG. 4. FIG. 4 is a diagram showing the change in the observation ratio of a coplanar response when the resistivity gradually decreases according to one embodiment of the present disclosure. When the resistivity of the target stratum gradually increases over time from [10⁻⁴, 10] S/m, the variation in the observation ratio of coplanar response with time is shown in FIG. 5. FIG. 5 is a diagram showing the change in the observation ratio of coplanar response when the resistivity gradually increases according to one embodiment of the present disclosure. Upon observing the changes in data in FIG. 4 and FIG. 5, it is found that when the time exceeds 10⁻⁵ seconds, the observation ratio of the response changes monotonically with increasing time. The full-area apparent resistivity of the target stratum can then be calculated by using search methods or similar techniques, so that the full-area apparent resistivity in the target stratum within the model 4 can be acquired.

The embodiments of the present disclosure, as outlined above, include determining the distance between the transmission antenna and the reception antenna of the exploration instrument, the air resistivity, the magnetic permeability of the vacuum, and the observation time range, wherein different observation times correspond to different probing depths. Based on the air resistivity, the magnetic permeability of the vacuum, the observation time range, the observation ratio, and the distance, the iterative calculation is used to acquire the full-area apparent resistivity of the target stratum. The approach enables processing of the observation signal by using the observation ratio to suppress the influence of drill collar on the observation data, thereby improving the calculation accuracy of full-area apparent resistivity.

The description below focuses on a device for determining a full-area apparent resistivity of a stratum as provided by the present disclosure, which corresponds to the previously described method for determining a full-area apparent resistivity of a stratum.

FIG. 6 is a schematic diagram illustrating a structure of the device for determining a full-area apparent resistivity of a stratum provided by the present disclosure. As illustrated in FIG. 6, the device for determining a full-area apparent resistivity of a stratum according to an embodiment of the present disclosure includes:
an acquisition module 21, configured to acquire suspension data of an exploration instrument in air and observation data within a target stratum; a first determination module 22, configured to determine an observation ratio based on the suspension data and the observation data; and
a second determination module 23, configured to determine the full-area apparent resistivity of the target stratum based on the observation ratio.

The second determination module 23 is further configured to: determine a distance between a transmission antenna and a reception antenna of the exploration instrument, an air resistivity, a magnetic permeability of a vacuum, and an observation time range, wherein different observation times within the observation time range correspond to different probing depths; and acquire the full-area apparent resistivity of the target stratum by using an iterative calculation based on the air resistivity, the magnetic permeability of the vacuum, the observation time range, the observation ratio, and the distance, wherein the full-area apparent resistivity includes a full-area apparent resistivity corresponding to a horizontal magnetic field component and a full-area apparent resistivity corresponding to a Z-axis vertical magnetic field component.

The device for determining a full-area apparent resistivity of a stratum further includes: for a coaxial transient magnetic field, the calculation formula for the full-area apparent resistivity corresponding to the Z-axis vertical magnetic field component is as follows.

$${RV}_{coa}^{21} ( t ) = {( \frac{{σ}_{2}}{{σ}_{1}} )}^{\frac{3}{2}} {e}^{\frac{{μ}_{0} {L}^{2}}{4 t} ( - {σ}_{2} + {σ}_{1} )} = {( \frac{{σ}_{2}}{t} / \frac{{σ}_{1}}{t} )}^{\frac{3}{2}} {e}^{\frac{{μ}_{0} {L}^{2}}{4} ( \frac{- {σ}_{2}}{t} )} {e}^{\frac{{μ}_{0} {L}^{2}}{4} ( \frac{{σ}_{1}}{t} )}$$

$${RV}_{coa}^{21}$$

is the observation ratio, σ₁ represents the air resistivity, σ₂ is the full-area apparent resistivity of the target stratum to be determined, μ₀ denotes the magnetic permeability of the vacuum, L is the distance, and t is the observation time.

The device for determining a full-area apparent resistivity of a stratum further includes: for a coplanar transient magnetic field, the calculation formula for the full-area apparent resistivity corresponding to the horizontal magnetic field component is as follows.

$$\begin{matrix}{RV}_{cop}^{21} ( t ) = {( \frac{{σ}_{4}}{{σ}_{3}} )}^{\frac{3}{2}} \frac{4 t - {μ}_{0} {σ}_{4} {L}^{2}}{4 t - {μ}_{0} {σ}_{3} {L}^{2}} {e}^{\frac{{μ}_{0} {L}^{2}}{4 t} ( - {σ}_{4} + {σ}_{3} )} \\ = {( \frac{{σ}_{4} / t}{{σ}_{3} / t} )}^{\frac{3}{2}} \frac{4 - {μ}_{0} {L}^{2} {σ}_{4} / t}{4 - {μ}_{0} {L}^{2} {σ}_{3} / t} {e}^{\frac{{μ}_{0} {L}^{2}}{4 t} ( \frac{- {σ}_{4}}{t} )} {e}^{\frac{{μ}_{0} {L}^{2}}{4 t} ( \frac{{σ}_{3}}{t} )}\end{matrix}$$

$${RV}_{cop}^{21} ( t )$$

is the observation ratio, σ₃ represents the air resistivity, σ₄ is the full-area apparent resistivity of the target stratum to be determined, μ₀ denotes the magnetic permeability of the vacuum, L is the distance, and t is the observation time.

The device for determining a full-area apparent resistivity of a stratum further includes: for the coaxial transient magnetic field, the suspension data and the observation data are data based on a Z-axis vertical magnetic field component measured by a Z-axis transmission antenna and a Z-axis reception antenna of the exploration instrument.

The first determination module 22 is further configured to: calculate and acquire an observation ratio corresponding to the Z-axis vertical magnetic field component based on the suspension data and the observation data corresponding to the Z-axis vertical magnetic field component.

The device for determining a full-area apparent resistivity of a stratum further includes: for the coplanar transient magnetic field, the suspension data and the observation data are data based on the horizontal magnetic field component measured by a horizontal transmission antenna and a horizontal reception antenna of the exploration instrument.

The first determination module 22 is further configured to: calculate and acquire the observation ratio corresponding to the horizontal magnetic field component based on the suspension data and the observation data corresponding to the horizontal magnetic field component.

It should be noted that the described device provided by the present embodiment of the present disclosure is capable of performing all the steps implemented by the method embodiment described above and achieves the same technical effects. Therefore, detailed descriptions of parts that are identical to the method embodiment and its beneficial effects are not repeated here.

FIG. 7 is a schematic structural diagram of an electronic device provided by the present disclosure. As shown in FIG. 7, this electronic device can include: a processor 310, a memory 320, a communications interface 330, and a communication bus 340, wherein the processor 310, the memory 320, and the communications interface 330 are communicated with each other via the communication bus 340. The processor 310 can invoke logic instructions in memory 320 to execute the method for determining a full-area apparent resistivity of a stratum. The method includes: acquiring suspension data of an exploration instrument in air and observation data within a target stratum; determining an observation ratio based on the suspension data and the observation data; and determining the full-area apparent resistivity of the target stratum based on the observation ratio.

Additionally, the logic instructions in the memory 320 can be implemented as software functional units and stored in a computer-readable storage medium when used as a standalone product. Based on the understanding, the essence of the technical solution of the present disclosure or the part contributing to the prior art may be embodied in the form of a software product stored in a storage medium. The computer software product comprises instructions that enable a computer device (such as a PC, a server, or a network device) to execute all or part of the steps of the methods described in various embodiments of the present disclosure. The storage medium includes a USB drive, a portable hard drive, a read-only memory (ROM), a random access memory (RAM), a magnetic disk, a optical disc, or any medium that can store program codes.

In another aspect, the present disclosure also provides a non-transitory computer-readable storage medium with a computer program stored thereon, and when executed by a processor, the computer program performs method for determining a full-area apparent resistivity of a stratum as provided by the methods above.

The device embodiments described above are only exemplary. The units described as separate components may or may not be physically separate. Components displayed as units may or may not be physical units; they may be located in one place or distributed across multiple networked units. Parts or all of the modules can be selected based on actual needs to achieve the objectives of this embodiment. One of ordinary skill in the art can understand and implement these modifications without creative effort.

Finally, it should be noted that the above embodiments are merely illustrative of the technical solutions of the present disclosure and should not be construed as limiting. Although the present disclosure has been described in detail with reference to the preceding embodiments, those skilled in the art will understand that modifications can still be made to the technical solutions described in each embodiment, or some technical features can be replaced with their equivalents. Such modifications or replacements do not depart from the essence of the corresponding technical solutions in the embodiments of the present disclosure.

What is claimed is:

1. A method for determining a full-area apparent resistivity of a stratum, comprising:
acquiring suspension data of an exploration instrument in air and observation data within a target stratum;
determining an observation ratio based on the suspension data and the observation data; and
determining the full-area apparent resistivity of the target stratum based on the observation ratio.

2. The method for determining a full-area apparent resistivity of a stratum according to claim 1, wherein determining the full-area apparent resistivity of the target stratum based on the observation ratio and a distance includes:
determining a distance between a transmission antenna and a reception antenna of the exploration instrument, an air resistivity, a magnetic permeability of a vacuum, and an observation time range, wherein different observation times within the observation time range correspond to different exploration depths; and
acquiring the full-area apparent resistivity of the target stratum by using an iterative calculation based on the air resistivity, the magnetic permeability of the vacuum, the observation time range, the observation ratio, and the distance, wherein the full-area apparent resistivity includes a full-area apparent resistivity corresponding to a horizontal magnetic field component and a full-area apparent resistivity corresponding to a Z-axis vertical magnetic field component.

3. The method for determining a full-area apparent resistivity of a stratum according to claim 2, wherein for a coaxial transient magnetic field, a calculation formula for the full-area apparent resistivity corresponding to the Z-axis vertical magnetic field component is as follows:
$${RV}_{coa}^{21} ( t ) = {( \frac{{σ}_{2}}{{σ}_{1}} )}^{\frac{3}{2}} {e}^{\frac{{μ}_{0} {L}^{2}}{4 t} ( - {σ}_{2} + {σ}_{1} )} = {( \frac{{σ}_{2}}{t} / \frac{{σ}_{1}}{t} )}^{\frac{3}{2}} {e}^{\frac{{μ}_{0} {L}^{2}}{4} ( \frac{- {σ}_{2}}{t} )} {e}^{\frac{{μ}_{0} {L}^{2}}{4} ( \frac{{σ}_{1}}{t} )}$$
wherein
$${RV}_{coa}^{21} ( t )$$
is the observation ratio, σ₁ is the air resistivity, σ₂ is the full-area apparent resistivity of the target stratum to be determined, μ₀ is the magnetic permeability of the vacuum, L is the distance, and t is the observation time.

4. The method for determining a full-area apparent resistivity of a stratum according to claim 2, wherein, for a coplanar transient magnetic field, a calculation formula for the full-area apparent resistivity corresponding to the horizontal magnetic field component is as follows:
$$\begin{matrix}{RV}_{cop}^{21} ( t ) = {( \frac{{σ}_{4}}{{σ}_{3}} )}^{\frac{3}{2}} \frac{4 t - {μ}_{0} {σ}_{4} {L}^{2}}{4 t - {μ}_{0} {σ}_{3} {L}^{2}} {e}^{\frac{{μ}_{0} {L}^{2}}{4 t} ( - {σ}_{4} + {σ}_{3} )} \\ = {( \frac{{σ}_{4} / t}{{σ}_{3} / t} )}^{\frac{3}{2}} \frac{4 - {μ}_{0} {L}^{2} {σ}_{4} / t}{4 - {μ}_{0} {L}^{2} {σ}_{3} / t} {e}^{\frac{{μ}_{0} {L}^{2}}{4 t} ( \frac{- {σ}_{4}}{t} )} {e}^{\frac{{μ}_{0} {L}^{2}}{4 t} ( \frac{{σ}_{3}}{t} )}\end{matrix}$$
wherein
$${RV}_{cop}^{21} ( t )$$
is the observation ratio, σ₃ is the air resistivity, σ₄ is the full-area apparent resistivity of the target stratum to be determined, μ₀ is the magnetic permeability of the vacuum, L is the distance, and t is the observation time.

5. The method for determining a full-area apparent resistivity of a stratum according to claim 1, wherein, for a coaxial transient magnetic field, the suspension data and the observation data are data based on a Z-axis vertical magnetic field component measured by a Z-axis transmission antenna and a Z-axis reception antenna of the exploration instrument; and
determining the observation ratio based on the suspension data and the observation data includes:
calculating and acquiring an observation ratio corresponding to the Z-axis vertical magnetic field component based on suspension data and observation data corresponding to the Z-axis vertical magnetic field component.

6. The method for determining a full-area apparent resistivity of a stratum according to claim 1, wherein, for a coplanar transient magnetic field, the suspension data and the observation data are data based on a horizontal magnetic field component measured by a horizontal transmission antenna and a horizontal reception antenna of the exploration instrument; and
determining the observation ratio based on the suspension data and the observation data includes:
calculating and acquiring an observation ratio corresponding to the horizontal magnetic field component based on suspension data and observation data corresponding to the horizontal magnetic field component.

7. A device for determining a full-area apparent resistivity of a stratum, comprising:
an acquisition module, configured to acquire suspension data of an exploration instrument in air and observation data within a target stratum;
a first determination module, configured to determine an observation ratio based on the suspension data and the observation data; and
a second determination module, configured to determine the full-area apparent resistivity of the target stratum based on the observation ratio.

8. The device for determining a full-area apparent resistivity of a stratum according to claim 7, wherein the second determination module is further configured to:
determine a distance between a transmission antenna and a reception antenna of the exploration instrument, an air resistivity, a magnetic permeability of a vacuum, and an observation time range, wherein different observation times within the observation time range correspond to different probing depths, and
acquire the full-area apparent resistivity of the target stratum by using an iterative calculation based on the air resistivity, the magnetic permeability of the vacuum, the observation time range, the observation ratio, and the distance, wherein the full-area apparent resistivity includes a full-area apparent resistivity corresponding to a horizontal magnetic field component and a full-area apparent resistivity corresponding to a Z-axis vertical magnetic field component.

9. The device for determining a full-area apparent resistivity of a stratum according to claim 8, wherein, for a coaxial transient magnetic field, a calculation formula for the full-area apparent resistivity corresponding to the Z-axis vertical magnetic field component is as follows:
$${RV}_{coa}^{21} ( t ) = {( \frac{{σ}_{2}}{{σ}_{1}} )}^{\frac{3}{2}} {e}^{\frac{{μ}_{0} {L}^{2}}{4 t} ( - {σ}_{2} + {σ}_{1} )} = {( \frac{{σ}_{2}}{t} / \frac{{σ}_{1}}{t} )}^{\frac{3}{2}} {e}^{\frac{{μ}_{0} {L}^{2}}{4} ( \frac{- {σ}_{2}}{t} )} {e}^{\frac{{μ}_{0} {L}^{2}}{4} ( \frac{{σ}_{1}}{t} )}$$
wherein
$${RV}_{coa}^{21} ( t )$$
is the observation ratio, σ₁ is the air resistivity, σ₂ is the full-area apparent resistivity of the target stratum to be determined, μ₀ is the magnetic permeability of the vacuum, L is the distance, and t is the observation time; and
for a coplanar transient magnetic field, a calculation formula for the full-area apparent resistivity corresponding to the horizontal magnetic field component is as follows:
$$\begin{matrix}{RV}_{cop}^{21} ( t ) = {( \frac{{σ}_{4}}{{σ}_{3}} )}^{\frac{3}{2}} \frac{4 t - {μ}_{0} {σ}_{4} {L}^{2}}{4 t - {μ}_{0} {σ}_{3} {L}^{2}} {e}^{\frac{{μ}_{0} {L}^{2}}{4 t} ( - {σ}_{4} + {σ}_{3} )} \\ = {( \frac{{σ}_{4} / t}{{σ}_{3} / t} )}^{\frac{3}{2}} \frac{4 - {μ}_{0} {L}^{2} {σ}_{4} / t}{4 - {μ}_{0} {L}^{2} {σ}_{3} / t} {e}^{\frac{{μ}_{0} {L}^{2}}{4 t} ( \frac{- {σ}_{4}}{t} )} {e}^{\frac{{μ}_{0} {L}^{2}}{4 t} ( \frac{{σ}_{3}}{t} )}\end{matrix}$$
wherein
$${RV}_{cop}^{21} ( t )$$
is the observation ratio, σ₃ is the air resistivity, σ₄ is the full-area apparent resistivity of the target stratum to be determined, μ₀ is the magnetic permeability of the vacuum, L is the distance, and t is the observation time.

10. The device for determining a full-area apparent resistivity of a stratum according to claim 7, wherein, for a coaxial transient magnetic field, the suspension data and the observation data are data based on a Z-axis vertical magnetic field component measured by a Z-axis transmission antenna and a Z-axis reception antenna of the exploration instrument, and
the first determination module is further configured to:
calculate and acquire an observation ratio corresponding to the Z-axis vertical magnetic field component based on suspension data and observation data corresponding to the Z-axis vertical magnetic field component.

11. The device for determining a full-area apparent resistivity of a stratum according to claim 7, wherein, for a coplanar transient magnetic field, the suspension data and the observation data are data based on a horizontal magnetic field component measured by a horizontal transmission antenna and a horizontal reception antenna of the exploration instrument; and
the first determination module is further configured to:
calculate and acquire an observation ratio corresponding to the horizontal magnetic field component based on suspension data and observation data corresponding to the horizontal magnetic field component.
